(19) United States
(12) Patent Application Publication
(10) Pub. No.: US 2024/0396263 A1
(43) Pub. Date: Nov. 28, 2024

(54) Housing Assembly for a Connector, Connector and Connection Assembly

(71) Applicants: TE Connectivity India Private Limited, Bangalore Karnataka (IN); TE Connectivity Czech s.r.o., Kurim (CZ)

(72) Inventors: Jagadeeshwarayya JUKTIHIREMATH, Bangalore (IN); Tomas SVATEK, Kurim (CZ); Miloslav HLAVINKA, Kurim (CZ); Dharmendrajain Vedalaveni PARSWANATHAIAH, Bangalore (IN); Martin DYCKA, Kurim (CZ)

(73) Assignees: TE Connectivity India Private Limited, Bangalore Karnataka (IN); TE Connectivity Czech s.r.o., Kurim (CZ)

(21) Appl. No.: 18/672,073

(22) Filed: May 23, 2024

(30) Foreign Application Priority Data
May 26, 2023 (IN) 202341036446

(51) Int. Cl. H01R 13/629

(52) U.S. Cl. CPC H01R 13/62938

(57) ABSTRACT

The present invention relates to a housing assembly for an electrical connector that is intermateable with a mating connector, wherein the housing assembly comprises: a connector housing and a lever for assisting a mating process between the electrical connector and the mating connector, wherein the connector housing comprises a receptacle for at least sectionally receiving the mating connector, wherein the lever is arranged on the connector housing movable between an initial position and a pre-lock position and comprises at least one lever arm with a blocking section, wherein the blocking section is located within the receptacle when the lever is in the initial position and wherein the blocking section is located outside of the receptacle when the lever is in the prelock position. Due to the blocking section being located in the receptacle, an operator tasked with the intermating is prevented from trying to forcefully mate the connectors without actuating the lever. Further, the present invention relates to an electrical connector with such a housing assembly. Moreover, the present invention relates to a connection assembly comprising such an electrical connector and a mating connector.

This application claims priority to and the benefit of Indian patent application No. 202341036446 filed May 26, 2023, which is hereby incorporated by reference in its entirety

### FIELD OF THE INVENTION

The present invention relates to a housing assembly for an electrical connector such as a plug connector, for e.g. automotive applications. Further, the present invention relates to an electrical connector with such a housing assembly. Moreover, the present invention relates to a connection assembly comprising such an electrical connector and a mating connector.

However, the applicability of the inventive concept is neither limited to electrical connectors nor to the automotive sector. For example, the concept of the present invention may also be used for other types of connectors (such as optical connectors) and may extend to other applications in the field of engineering.

### BACKGROUND

In applications involving the transmission of electrical power and/or electrical signals, spaced-apart technical units may have to be electrically connected via electrical cables in a separable fashion, e.g. using electrical connectors. When establishing such an electrical connection by intermating a pair of matching electrical connectors (i.e. connector and mating connector), certain internal resistance forces usually have to be overcome.

In order to facilitate this step, so-called mating aid levers can be provided. These mating aid levers are often operated manually to pull and/or push together the electrical connector and its mating connector to establish the electrical connection. By means of the leverage effect, such mating aid lever reduces the required mating force that has to be applied by an operator in order to overcome said internal resistance forces.

However, these mating aid levers can also be the cause of installation errors if operated improperly. For example, the operator could erroneously attempt to completely intermate the electrical connector and mating connector by sheer force without using the lever. The resulting state might appear to be in order, but the electrical connection is likely not functional.

### SUMMARY

The object of the present invention is to improve the handling of electrical connectors in general, and to prevent installation errors, in particular.

This object is achieved by a housing assembly for an electrical connector that is intermateable with a mating connector, wherein the housing assembly comprises a connector housing and a lever for assisting a mating process between the electrical connector and the mating connector, wherein the connector housing comprises a receptacle for at least sectionally receiving the mating connector, wherein the lever is arranged on the connector housing movable between an initial position and a pre-lock position and comprises at least one lever arm with a blocking section, wherein the blocking section is located within the receptacle when the lever is in the initial position and wherein the blocking section is located outside of the receptacle when the lever is in the prelock position.

The above-mentioned solution is advantageous, since the lever can function as the above-described mating aid lever. Further, the housing assembly, when used in the electrical connector, can prevent installation errors as follows: Normally, the electrical connector is supplied with the housing assembly having its lever in the initial position. Due to the blocking section being located in the receptacle, the insertion of any mating connector into the receptacle is blocked until the operator actually moves the lever into the pre-lock position. Thus, by blocking the insertion, the operator is directly prevented from trying to mate the connectors without actuating the lever. Moreover, the operator is also incentivized to actuate the lever during the mating process.

The above solution may further be improved by adding one or more of the following optional features. Each of the following optional features is advantageous on its own and may be combined independently with any other optional feature.

According to a first possible embodiment, the electrical connector is preferably intermateable with the mating connector along a mating direction. The receptacle may be part of a mating face designed complementarily to a counterpart mating face of the mating connector. This facilitates handling of the electrical connector and mating connector.

Further, the blocking section may provide an abutment surface that faces outward of the receptacle when the lever is in the initial position. The abutment surface facing outward of the receptacle may comprise a normal vector points outward of the receptacle. Said normal vector is preferably parallel to the mating direction. Thus, the abutment surface hinders the mating connector from entering the receptacle, as long as the lever is in the initial position.

According to another possible embodiment that is easy to manufacture, the blocking section may project towards the connector housing. In particular, the blocking section may be formed by a protrusion that extends into the receptacle when the lever is in the initial position. The abutment surface may be located at a front end of the protrusion. For example, the protrusion may be a rib running along the mating direction when the lever is in the initial position. Moreover, the protrusion may move outside of and thus clear the receptacle when the lever is in the pre-lock position.

In order to achieve the movement of the blocking section within a compact and limited space, the blocking section preferably travels along an arcuate trajectory when the lever is moved from the initial position to the pre-lock position. Specifically, the blocking section may travel along a circular trajectory when the lever is moved from the initial position to the pre-lock position. To implement this, the lever may be arranged pivotable and/or rotatable on the connector housing. In particular, the lever may be pivotable and/or rotatable about a pivot axis, wherein the blocking section, in particular its abutment surface is spaced apart from the pivoting axis, preferably in a radial direction with respect to the pivot axis.

The pivot axis may be fixed in that the connector housing comprises at least one axle journal for pivotably holding the lever. The lever comprises at least one bearing hole for at least partially receiving the at least one axle journal. The blocking section may then be radially offset with respect to the center of the at least one bearing hole.

Optionally, the blocking section may comprise a chamfer adjacent to the abutment surface. The chamfer is preferably spaced apart further from the pivot axis than the abutment surface. In other words, the abutment surface may be closer than the chamfer to the pivot axis. The chamfer thus facilitates the movement of the blocking section along the arcuate trajectory, since it prevents any corners of the blocking section from jamming. Instead of a chamfer, a rounded edge may also be provided adjacent to the abutment surface.

According to another possible embodiment, the connector housing may comprise a housing pocket adjacent to the receptacle, wherein the blocking section is located within the housing pocket when the lever is in the pre-lock position. The housing pocket thus provides an evasion space for the blocking section. In particular, the blocking section may be swiveled into the housing pocket when the lever is pivoted from the initial position into the pre-lock position.

Preferably, the blocking section is fully received within the housing pocket when the lever is in the pre-lock position. Thereby, interference between the blocking section and the mating connector can be eliminated when the lever is in the pre-lock position.

A further elimination of interference can be achieved in an embodiment, in which the blocking section is located on opposite sides of the pivot axis when the lever is in the pre-lock position and when the lever is in the initial position. In particular, the pivot axis and the mating direction may jointly span a plane, wherein the blocking section is moved through said plane when the lever is pivoted from the initial position to the pre-lock position and vice versa.

For increased stability, the lever may comprise two lever arms. Further, the lever may be U-shaped and may at least partially encompass the connector housing. Each lever arm may comprise one blocking section. Moreover, the blocking sections of the two lever arms may face each other and project inwards and towards the connector housing.

The object of the invention defined at the outset can also be achieved by an electrical connector with a housing assembly according to one of the preceding embodiments, wherein at least one electrical contact element for contacting a mating contact of the mating connector is positioned in the connector housing. Depending on the field of use of the electrical connector, a plurality of contact elements may optionally be arranged in the connector housing. Due to the functionality and advantages of the housing assembly, which have already been explained above, the electrical connector according to the present invention can be handled easily and with low to no risk of installation errors.

The object of the present invention defined at the outset can further be achieved by a connection assembly comprising an electrical connector according to one of the preceding embodiments and a mating connector that is configured to be insertable into the receptacle of the electrical connector, wherein the mating connector is provided with at least one driven element that is arranged to be engageable with the lever.

In turn, the lever may comprise at least one drive element that is arranged to be engaged with the at least one driven element of the mating connector. The at least one drive element may be arranged on the at least one lever arm adjacent to the blocking section. In particular, the at least one drive element may be located at a base of the blocking section or vice versa.

For example, the at least one driven element may be a toothed rack extending in or obliquely to the mating. The at least one drive element may be a single gear tooth formed complementarily to the toothed rack. Alternatively, the at least one drive element may be a gear segment partially extending around the at least one bearing hole in a circumferential direction with respect to the pivot axis.

The connector assembly according to the present invention also benefits from the advantages of the housing assembly. Due to the above-described interaction between the blocking section and the mating connector, an installation error can be prevented effectively.

According to one possible embodiment, the connection assembly may comprise a first state in which the mating connector is inserted into the receptacle of the electrical connector, the lever is in the initial position and the blocking section abuts against the mating connector. In particular, the abutment surface of the blocking section may abut against a stop surface of a shoulder formed on the mating connector. This abutment remains as long as the lever stays in the initial position.

Preferably, in this first state, which may also be referred to as a pre-insertion state, the mating connector can only be inserted into the receptacle of the electrical connector up to a depth where the distance between any electrical contact element and any mating contact is larger than the air and creepage distance. This insertion depth limitation prevents arcing, while the connection assembly is in the first state.

According to another possible embodiment, the connection assembly may comprise a second state in which the lever is in the pre-lock position and the blocking section is moved out of the abutment with the mating connector. In particular, the blocking section is outside of the receptacle and preferably inside of the above-mentioned housing pocket. Thereby, the mating connector can be inserted further into the receptacle of the electrical connector. Hence, this second state may also be referred to as an insertion state that confirms the correct positioning of the lever.

Additionally or alternatively, the connection assembly may comprise a third state, in which the mating connector is inserted further into the receptacle of the electrical connector compared to the first state, the lever is in the pre-lock position, and a movement of the lever into the initial position is blocked by the mating connector. For this purpose, the mating connector may comprise a resting surface on the above-mentioned shoulder of the mating connector. The resting surface of the shoulder may cover the housing pocket for the duration of the third state, thus preventing the blocking section from moving out of the housing pocket and hindering the lever from moving into the initial position.

Optionally, the blocking section may comprise a sliding surface opposite the abutment surface. The sliding surface may be located at a back end of the above-mentioned protrusion. When the lever is in the pre-lock position and the connection assembly is in the third state, the sliding surface may be flush with the housing pocket. Further, the sliding surface may rest against the resting surface of the shoulder.

In the first, second and third state, the at least one drive element and the at least one driven element are not yet in engagement. Moreover, the third state prevails as long as said engagement does not occur. Hence, this third state may also be referred to as a pre-engagement state.

In order for the engagement between the at least one drive element and the at least one driven element to occur, the electrical connector and mating connector need to be pushed together up to a certain insertion depth. Along the way, the sliding surface of the lever may slide on the resting surface of the shoulder. Once the engagement occurs, the resting surface has moved past the housing pocket. This marks a fourth state of the connection assembly: the engagement state.

In the fourth state, the mating connector is inserted further into the receptacle of the electrical connector compared to the third state. The at least one drive element is in engagement with the at least one driven element, and the lever is movable from the pre-lock position to the initial position. This guarantees that the lever is only actuated by the operator if the at least one drive element is actually in engagement with the at least one driven element and not prematurely.

By moving the lever from the pre-lock position back into the initial position, the rotational lever movement is converted into a translational mating movement of the connectors via the drive and driven element. This brings the connection assembly into a fifth state, which may also be referred to as the (fully) mated state.

The initial position of the lever may coincide with a final position of the lever. In other words, the connection assembly is moved back and forth in the course of the intermating process. Alternatively, the final position may be located past the initial position and away from the pre-lock position.

Optionally, the housing assembly may comprise a slidable CPA (connector position assurance) element for retaining the lever in the final position. As further optional features, the connector housing and the lever may each comprise at least one latching element for securing the lever in a pre-defined position, such as the initial position, the pre-lock position and/or the final position.

The different states of the connection assembly are named the first, second, third, fourth and fifth state merely based on the order in which they are explained in this description. However, this should not be understood as implying a temporal and/or causal limitation. Depending on the application of the connection assembly, the pre-insertion state, the insertion state, the pre-engagement state and the engagement state may also exist in another combination and/or sequence.

In the following, exemplary embodiments of the invention are described with reference to the drawings. The embodiments shown and described are for explanatory purposes only. The combination of features shown in the embodiments may be changed according to the foregoing description. For example, a feature which is not shown in an embodiment but described above, may be added if the technical effect associated with this feature is beneficial to a particular application. Vice versa, a feature shown as part of an embodiment may be omitted as described above if the technical effect associated with this feature is not needed in a particular application.

In the drawings, elements that correspond to each other with respect to function and/or structure have been provided with the same reference numeral.

### BRIEF DESCRIPTION OF THE DRAWINGS

FIG. 1 shows a schematic illustration of a perspective view of an electrical connector according to one possible embodiment of the present disclosure;

FIG. 2 shows a schematic illustration of a perspective view of a mating connector according to one possible embodiment of the present disclosure;

FIG. 3 shows a schematic illustration of a perspective view of a mating aid lever according to one possible embodiment of the present disclosure in an initial position;

FIG. 4 shows a schematic illustration of a side view of the mating aid lever shown in FIG. 3 in a pre-lock position;

FIG. 5 shows a schematic illustration of a perspective sectional view of a connection assembly according to one possible embodiment of the present disclosure in a first state;

FIG. 6 shows a schematic illustration of the detail VI of FIG. 5;

FIG. 7 shows a schematic illustration of a sectional side view of the connection assembly shown in FIG. 5 in a second state;

FIG. 8 shows a schematic illustration of a sectional side view of the connection assembly shown in FIG. 5 in a third state;

FIG. 9 shows a schematic illustration of another sectional side view of the connection assembly shown in FIG. 5 in the third state;

FIG. 10 shows a schematic illustration of another sectional side view of the connection assembly shown in FIG. 5 in a fourth state;

FIG. 11 shows a schematic illustration of another sectional side view of the connection assembly shown in FIG. 5 in a fifth state; and

FIG. 12 shows a schematic illustration of a perspective view of a connector housing according to a possible embodiment of the present disclosure.

### DETAILED DESCRIPTION

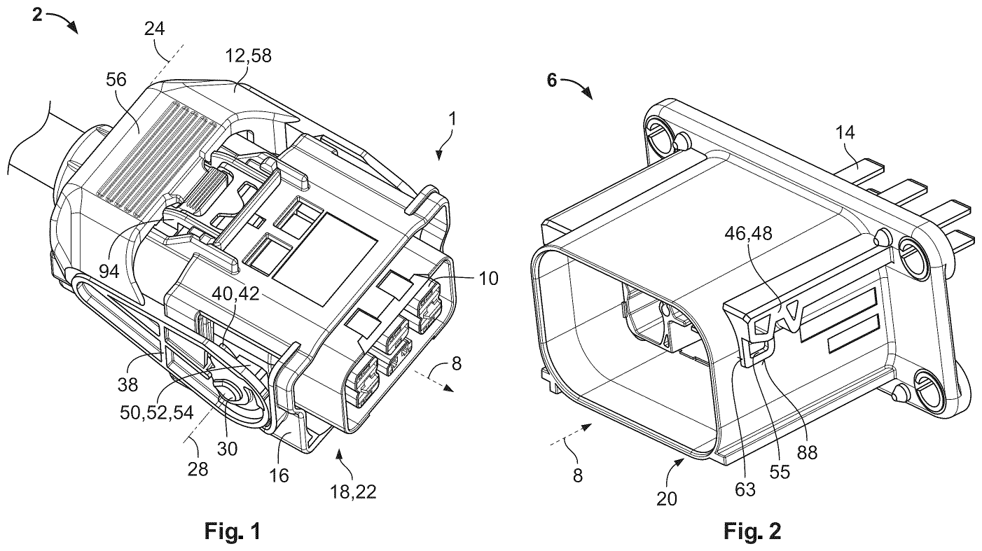

In the following, the structure of a housing assembly 1 is explained with reference to the exemplary embodiments shown in FIGS. 1 to 12. The structure of an electrical connector 2, and a connection assembly 4 according to the present invention will be explained as well.

FIG. 1 shows a perspective view of an exemplary embodiment of the electrical connector 2 that is intermateable with a mating connector 6 along a mating direction 8 (see FIG. 2). The electrical connector 2 and mating connector 6 together form the connection assembly 4.

The electrical connector 2 comprises the housing assembly 1 according to the present invention.

Positioned in the housing assembly 1, the electrical connector 2 comprises at least one electrical contact element 10 for contacting a mating contact 14 of the mating connector 6.

As shown in FIG. 1, the housing assembly 1 comprises a connector housing 16. The connector housing 16 may be an injection-molded plastic part and may comprise as such a mating face 18. The mating face 18 may face in the mating direction 8 and may be designed complementarily to a counter-part mating face 20 of the mating connector 6 (see FIG. 2). As part of the mating face 18, the connector housing 16 comprises a receptacle 22 for at least sectionally receiving the mating connector 6. In other words, the mating connector 6 is configured to be insertable into the receptacle 22 of the electrical connector 1.

The housing assembly 1 further comprises a mating aid lever 12 for assisting a mating process between the electrical connector 2 and the mating connector 6. The mating aid lever 12 may also be an injection-molded plastic part.

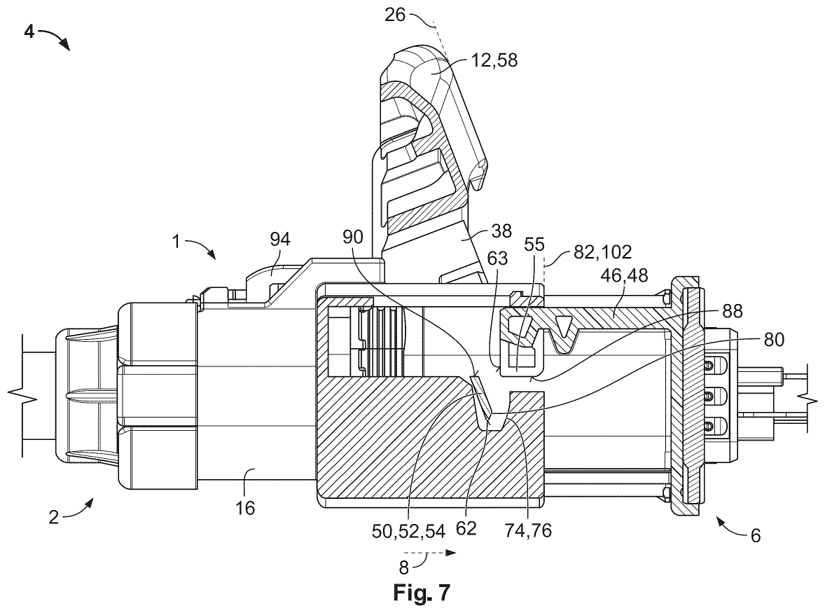

The mating aid lever 12 is arranged on the connector housing 16 movable between an initial position 24 (see FIG. 1) and a pre-lock position 26 (see FIG. 7). In particular, the mating aid lever 12 is pivotable or rotatable from the initial position 24 to the pre-lock position 26 and back. As such, the mating aid lever 12 may be pivotable about a pivot axis 28, more specifically a fixed pivot axis.

For this purpose, the connector housing 16 may comprise at least one axle journal 30 for pivotably holding the mating aid lever 12. In turn, the mating aid lever 12 may comprise at least one bearing hole 32 for at least partially receiving said axle journal 30. The pivot axis 28 as well as the at least one axle journal 30 and the at least one bearing hole 32 extend perpendicularly to the mating direction 8. If multiple axle journals 30 and holes 32 are provided, they are preferably mutually parallel and coaxial, in particular parallel and coaxial with the pivot axis 28.

Between a distal end and a proximal end of the at least one axle journal 30, a substantially cylindrical bearing surface 34 for the mating aid lever 12 may extend on the at least one axle journal 30. Optionally, the at least one axle journal 30 may comprise the distal end with a tear-shaped flange 36. In this case, the at least one bearing hole 32 may correspondingly also be tear-shaped. During assembly of the mating aid lever 12 to the connector housing 16, the at least one axle journal 30 can only be received in the at least one bearing hole 32 when the mating aid lever 12 is in a correct assembly position (not shown) and the above-mentioned tear-shaped elements coincide. Conversely, the mating aid lever 12 cannot be removed from the connector housing 16, unless the mating aid lever is brought into the assembly position.

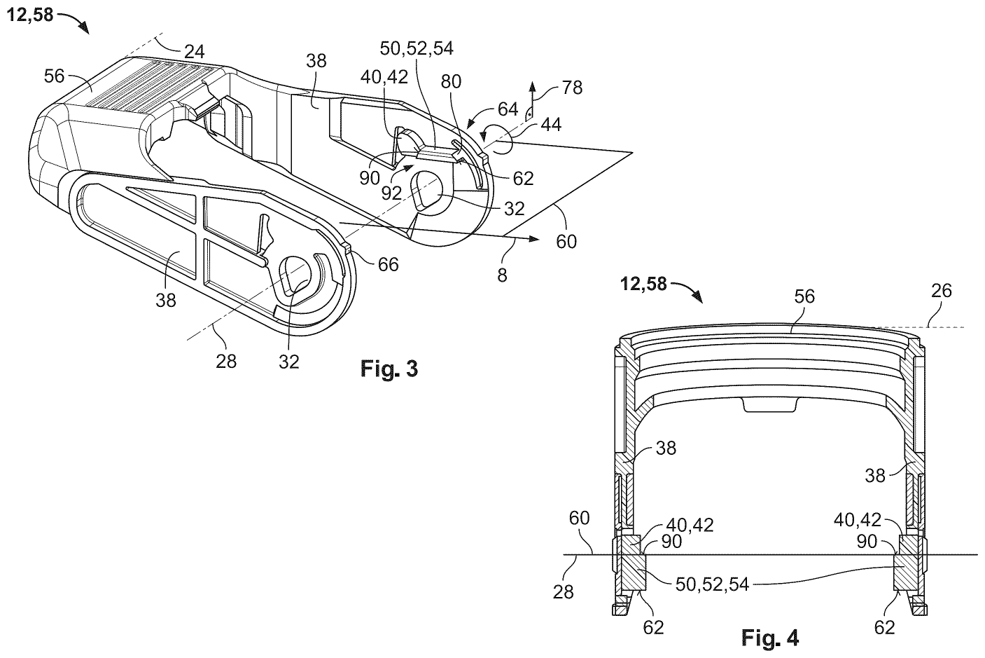

The mating aid lever 12 comprises at least one lever arm 38 with a drive element 40 (see FIG. 3) and is configured to be manually operated. In the shown embodiment, the drive element 40 is a single gear tooth 42. Alternatively, the drive element 40 may also be a gear segment (not shown) partially extending around the at least one bearing hole 32 in a circumferential direction 44 with respect to the pivot axis 28.

As an alternative to the at least one drive element 40 being a gear segment, the at least one drive element 40 may also be a friction wheel or a friction wheel segment (not shown). Alternatively, the at least one drive element 40 may be an eccentric cam wheel or cam wheel segment (not shown).

The mating connector 6 may be provided with at least one driven element 46 that is arranged to be engageable with the mating aid lever 12, in particular with the at least one drive element 40. The at least one driven element 46 may be, for example, a toothed rack 48 extending in or obliquely to the mating direction 8. The toothed rack 48 is preferably shaped complementarily to the gear tooth 42.

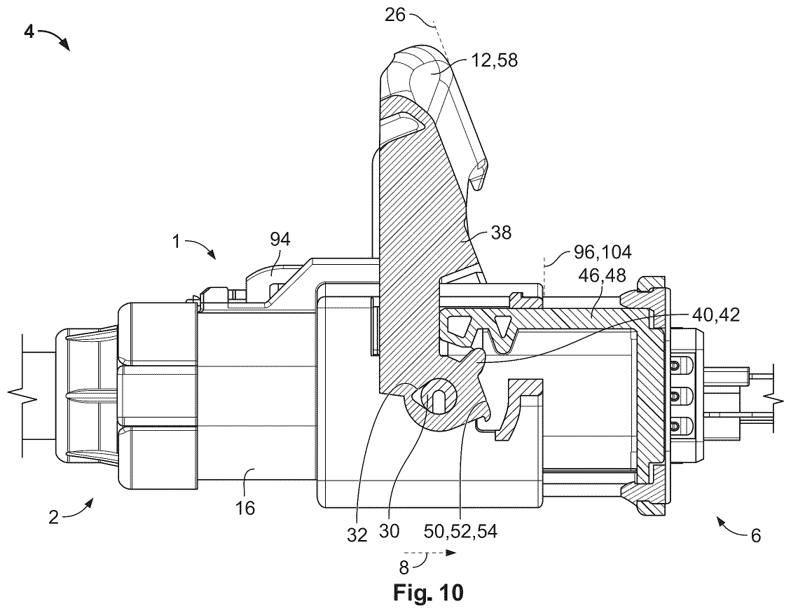

When the at least one drive element 40 and at least one driven element 46 are in engagement with each other (see FIG. 10), they are form-fittingly intermeshed or interlocked. Moving the mating aid lever 12 during this engagement causes a rotational lever movement to be converted into a translational relative movement between the electrical connector 1 and mating connector 6. If the mating aid lever 12 is moved from the pre-lock position 26 into the initial position 24, a translational mating movement results. If the mating aid lever 12 is moved from the initial position 24 into the pre-lock position 26, a translational un-mating movement ensues.

On the at least one lever arm 38 and adjacent to the at least one drive element 40, the mating aid lever 12 comprises a blocking section 50 (see FIG. 3). In particular, the blocking section 50 may be located at a base of the at least one drive element 40 and vice versa. Alternatively, the at least one drive element 40 and the blocking section 50 may be spaced apart.

The blocking section 50 may project towards the connector housing 16 when the mating aid lever 12 is arranged on the connector housing 16. As can be seen in FIG. 3, the blocking section 50 may be formed by a protrusion 52, for example a rib 54 running along the mating direction 8 when the mating aid lever 12 is in the initial position 24.

Optionally, the mating aid lever 12 may comprise two lever arms 38. Further, the mating aid lever 12 may be U-shaped and may at least partially encompass the connector housing 16 (see FIG. 1). The two lever arms 38 may be joined by a handle 56 so as to form a structural unit 58. In other words, the mating aid lever 12 may be an integral component. According to an alternative embodiment not shown, the mating aid lever 12 may also be a multipart component. In particular, the two lever arms may be configured to be separable from each other. Optionally, the lever may include a detachable connecting element via which the two lever arms are connectable to result in the above-mentioned U-shape.

Each lever arm may comprise one blocking section 50. The blocking sections 50 of the two lever arms 38 may face each other and project inwards. The function of the blocking sections 50 will be described below exemplary for one blocking section 50.

When the mating aid lever 12 is in the initial position 24, the blocking section 50 is located within the receptacle 22. In particular, the protrusion 52 extends into the receptacle 22 when the mating aid lever 12 is in the initial position 24. Moreover, the blocking section 50 is located outside the receptacle 22 when the mating aid lever 12 is in the pre-lock position 26. That is, the blocking section 50 moves outside (and thereby clears) the receptacle 22 when the mating aid lever 12 is moved into the pre-lock position 26.

As can be seen from a juxtaposition of FIGS. 3 and 4, the blocking section 50 is preferably located on opposite sides of the pivot axis 28 when the mating aid lever 12 is in the pre-lock position 26 and when the mating aid lever 12 is in the initial position 24. That is, the blocking section 50 is above the pivot axis 28 in FIG. 3 and below the pivot axis in FIG. 4. In other words, the pivot axis 28 and the mating direction 8 jointly span a plane 60, wherein the blocking section 50 is moved through said plane 60 when the mating aid lever 12 is pivoted from the initial position 24 to the pre-lock position 26 and vice versa.

Preferably, the blocking section 50 provides an abutment surface 62 that faces outwards of the receptacle 22 when the mating aid lever 12 is in the initial position 24. The abutment surface 62 may be located at a front end 64 of the above-mentioned protrusion 52. Further, the abutment surface 62 may exhibit a normal vector of the surface pointing outwards of the receptacle 22.

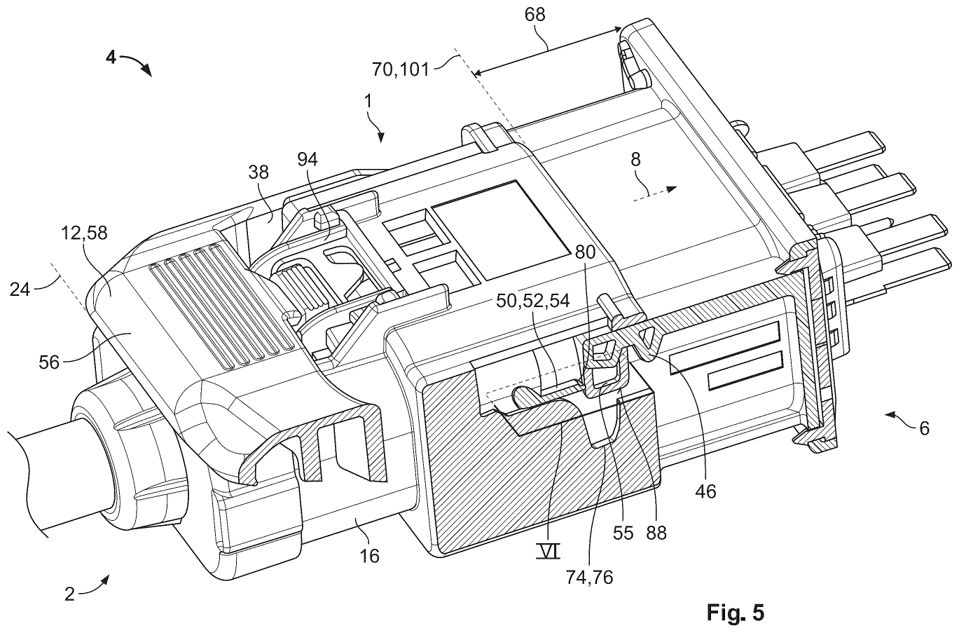

FIGS. 5 to 11 represent a sequence showing the interaction between the mating aid lever 12 and mating connector 6 when establishing an electrical connection between the electrical connector 2 and the mating connector 6. First, the electrical connector 2 is placed on the mating connector 6 with the counter-part mating face 20 inserted into the mating face 18, while the mating aid lever 12 is in the initial position 24.

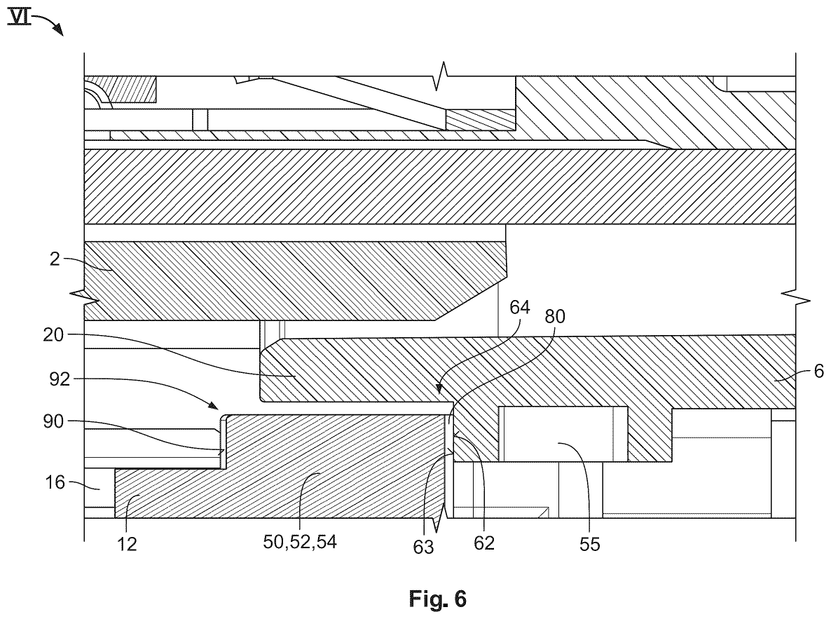

In this first state 101 of the connection assembly 4, the blocking section 50, more particularly its abutment surface 62, prevents the mating connector 6 from completely entering the receptacle 22. This is shown best in FIGS. 5 and 6. There, the blocking section 50 can be seen abutting against a stop surface 63 of a shoulder 55 formed on the mating connector 6. This abutment remains as long as the mating aid lever 12 stays in the initial position 24. Given the large gap 68 between the connectors 2, 6, an operator (not shown) tasked with the mating of the connectors 2, 6, will clearly recognize that in this state, the mating process is not yet finished.

Preferably, in this first state 101, which may also be referred to as a pre-insertion state 70, the mating connector 6 can only be inserted into the receptacle 22 of the electrical connector 1 up to a depth where the distance between any electrical contact element 10 and any mating contact 14 is larger than the air and creepage distance. As shown in FIG. 1, the electrical connector 1 is supplied with the housing assembly 1 having its mating aid lever 12 in the initial position 24. Due to the blocking section 50 in the receptacle 22, the insertion of the mating connector 6 is blocked until the operator moves the mating aid lever 12 into the pre-lock position 26. This insertion depth limitation prevents arcing in case the connectors 2, 6 are mated without actuating the mating aid lever 12.

In order to continue the mating process, the blocking section 50 needs to be brought out of abutment with the stop surface 63 of the shoulder 55. For this, the operator moves the mating aid lever 12 into the pre-lock position 26 as a next step. As already described above, this will cause the blocking section 50 to move outside of the receptacle 22 bringing the connection assembly 4 into a second state 102 (see FIG. 7).

For example, the connector housing 16 may comprise a housing pocket 74 serving as an evasion space 76 for the blocking section 50. The housing pocket 74 may be located adjacent to the receptacle 22. The blocking section 50 is preferably located within the housing pocket 74 when the mating aid lever 12 is in the pre-lock position 26. In particular, the blocking section 50 may be fully received within the housing pocket 74 when the mating aid lever 12 is in the pre-lock position 26.

As shown in FIG. 3, the blocking section 50 may be spaced apart from the pivot axis 28, preferably in a radial direction 78 with respect to the pivot axis 28. In other words, the blocking section 50 may be radially offset with respect to the center of the at least one bearing hole 32. Thereby, the blocking section 50 travels along an arcuate trajectory when the mating aid lever 12 is moved, pivoted or rotated from the initial position 24 to the pre-lock position 26. In particular, the blocking section 50 may be swiveled into the housing pocket 74 when the mating aid lever 12 is pivoted from the initial position 24 to the pre-lock position 26.

Optionally, the blocking section 50 may comprise a chamfer 80 adjacent to the abutment surface 62. The chamfer 80 facilitates the movement of the blocking section 50 along the arcuate trajectory into the housing pocket 74, since it prevents any corners of the blocking section 50 from jamming at the shoulder 55.

Since the blocking section 50 is outside of the receptacle 22 and preferably inside of the housing pocket 74, the mating connector 6 can be inserted further into the receptacle 22 of the electrical connector 1. Therefore, this second state 102 may also be referred to as an insertion state 82.

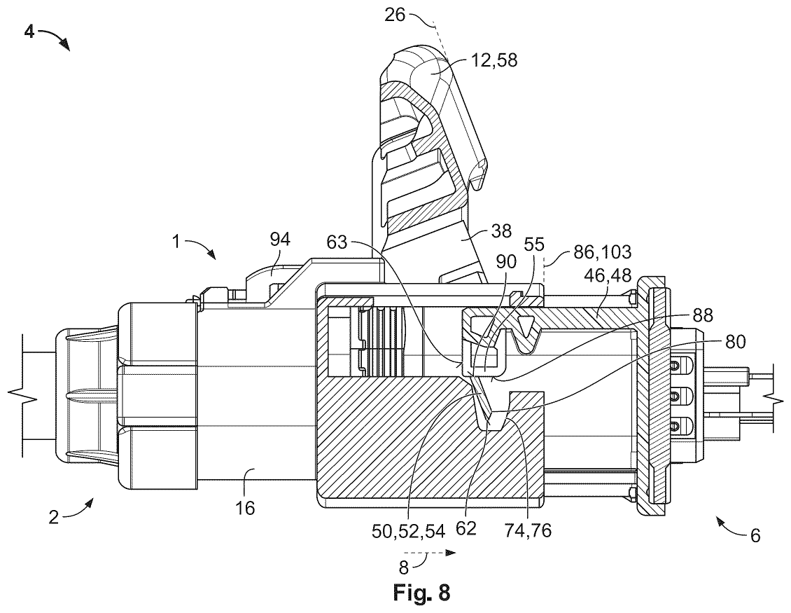

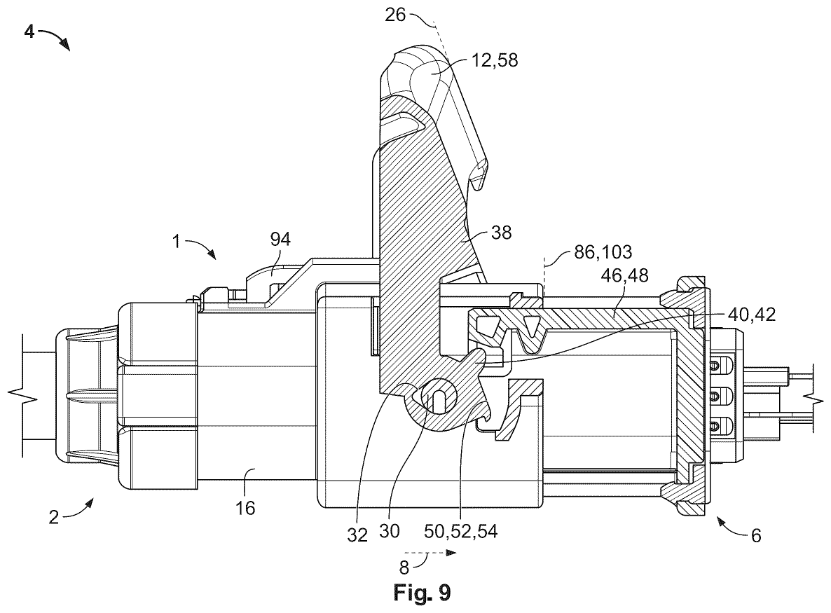

The second state 102 may be followed by a third state 103 of the connection assembly 4 shown in FIGS. 8 and 9. Here, the at least one drive element 40 and the at least one driven element 46 are not yet in engagement. The third state 103 prevails as long as said engagement does not occur. Hence, this third state 103 may also be referred to as a pre-engagement state 86.

In order to maintain the mating aid lever 12 in the pre-lock position 26 and prevent it from being moved, pivoted or rotated prematurely during the third state 103, a movement of the mating aid lever 12 into the initial position 24 is blocked by the mating connector 6.

For this purpose, the mating connector 6 may comprise a resting surface 88 on the shoulder 55. The resting surface 88 may extend obliquely, in particular perpendicularly to the stop surface 63. The resting surface 88 and the stop surface 63 may jointly form a corner of the shoulder 55. Further, the resting surface 88 of the shoulder 55 may cover the housing pocket 74 for the duration of the third state 103, thus preventing the blocking section 50 from moving out of the housing pocket 74 and hindering the mating aid lever 12 from pivoting.

Optionally, the blocking section 50 may comprise a sliding surface 90 opposite the abutment surface 62. The sliding surface 90 may be located at a back end 92 of the above-mentioned protrusion 52. When the mating aid lever 12 is in the pre-lock position 26 and the connection assembly 4 is in the third state 103 (i.e. pre-engagement state 86), the sliding surface 90 may be flush with the housing pocket 74. Further, the sliding surface 90 may rest against the resting surface 88 of the shoulder 55 (see FIG. 8).

In order for the engagement between the at least one drive element 40 and the at least one driven element 46 to occur, the electrical connector 1 and mating connector 6 need to be pushed together up to a certain insertion depth (see FIG. 10). Once the engagement occurs, the resting surface has moved past the housing pocket 74 and lever pivoting is possible (again). Along the way, the sliding surface 90 may slide on the resting surface 88 of the shoulder 55.

In this resulting fourth state 104, the mating connector 6 is inserted further into the receptacle 22 of the electrical connector 1 compared to the third state 103. Moreover, the at least one drive element 40 is in engagement with the at least one driven element 46, and the mating aid lever 12 is movable from the pre-lock position 26 back to the initial position 24. Therefore, the fourth state 104 may also be referred to as an engagement state 96.

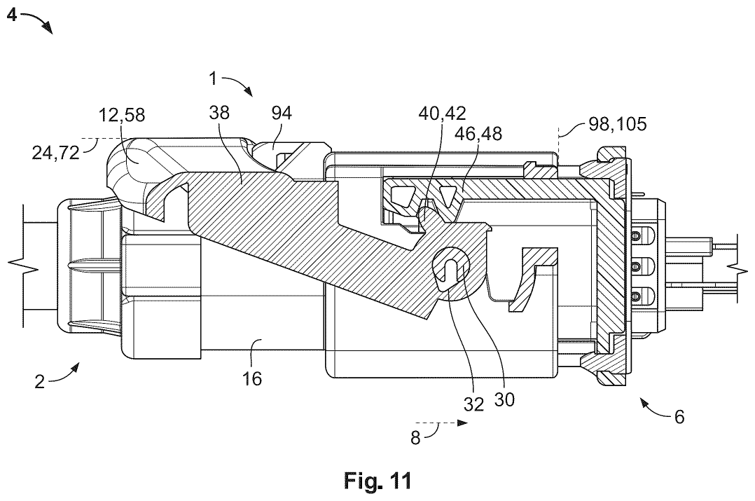

From the fourth state 104, the connection assembly 4 may be brought into a fifth state 105, by moving, pivoting or rotating the mating aid lever 12 from the pre-lock position 26 to the initial position 24 (see FIG. 11). As already described above, this creates the translational relative movement between the electrical connector 1 and mating connector 6, completely mating both connectors 2, 6. Therefore, the fifth state 105 may also be referred to as the (fully) mated state 98.

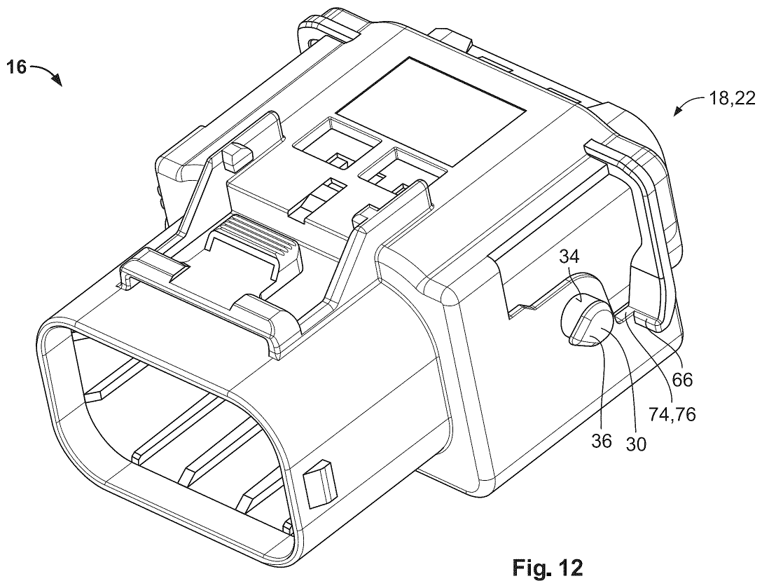

The initial position 24 may coincide with a final position 72 of the mating aid lever 12. Alternatively, the final position 72 may be located past the initial position 24 and away from the pre-lock position 26. Optionally, the housing assembly 1 may comprise a slidable CPA (connector position assurance) element 94 for retaining the mating aid lever 12 in the final position 72 (see FIG. 11). Alternatively, the connector housing 16 and the mating aid lever 12 may each comprise at least one latching element 66 (see FIGS. 3 and 12) for securing the mating aid lever 12 in a pre-defined position, such as the initial position 24, the pre-lock position 26, the final position 72 and/or assembly position (not shown).

Depending on the application of the connection assembly 4, the pre-insertion state 70, the insertion state 82, the pre-engagement state 86 and the engagement state 96 may also exist in another combination and/or sequence.

### REFERENCE NUMERALS

1 housing assembly
2 electrical connector
4 connection assembly
6 mating connector
8 mating direction
10 contact element
12 mating aid lever
14 mating contact
16 connector housing
18 mating face
20 counter-part mating face
22 receptacle
24 initial position
26 pre-lock position
28 pivot axis
30 axle journal
32 bearing hole
34 bearing surface
36 tear-shaped flange
38 lever arm
40 drive element
42 gear tooth
44 circumferential direction
46 driven element
48 toothed rack
50 blocking section
52 protrusion
54 rib
55 shoulder
56 handle
58 structural unit
60 plane
62 abutment surface
63 stop surface
64 front end
66 latching element
68 gap
70 pre-insertion state
72 final position
74 housing pocket
76 evasion space
78 radial direction
80 chamfer
82 insertion state
86 pre-engagement state
88 resting surface
90 sliding surface
92 back end
94 CPA element
96 engagement state
98 mated state
101 first state
102 second state
103 third state
104 fourth state
105 fifth state

We claim:

1. A housing assembly for an electrical connector that is intermateable with a mating connector, the housing assembly comprising:
a connector housing and
a lever for assisting a mating process between the electrical connector and the mating connector,
wherein the connector housing comprises a receptacle for at least sectionally receiving the mating connector
wherein the lever is arranged on the connector housing movable between an initial position and a pre-lock position and comprises at least one lever arm (38) with a blocking section
wherein the blocking section is located within the receptacle when the lever is in the initial position and wherein the blocking section is located outside of the receptacle when the lever is in the pre-lock position.

2. The housing assembly according to claim 1, wherein the blocking section provides an abutment surface that faces outwards of the receptacle when the lever is in the initial position.

3. The housing assembly according to claim 1, wherein the blocking section projects towards the connector housing.

4. The housing assembly according to claim 1, wherein the blocking section is formed by a protrusion that extends into the receptacle when the lever is in the initial position, and that clears the receptacle when the lever is in the pre-lock position.

5. The housing assembly according to claim 1, wherein the blocking section travels along an arcuate trajectory when the lever is moved from the initial position to the pre-lock position.

6. The housing assembly according to claim 1, wherein the connector housing comprises a housing pocket adjacent to the receptacle, wherein the blocking section is located within the housing pocket when the lever is in the pre-lock position.

7. The housing assembly according to claim 6, wherein the blocking section is fully received within the housing pocket when the lever is in the pre-lock position.

8. The housing assembly according to claim 1, wherein the lever is pivotable about a pivot axis, and wherein the blocking section is spaced apart from the pivoting axis.

9. The housing assembly according to claim 8, wherein the blocking section is located on opposite sides of the pivot axis when the lever is in the pre-lock position and when the lever is in the initial position.

10. An electrical connector with a housing assembly according to claim 1, wherein at least one electrical contact element for contacting a mating contact of the mating connector is positioned in the connector housing.

11. A connection assembly comprising an electrical connector according to claim 10 and a mating connector that is configured to be insertable into the receptacle of the electrical connector, wherein the mating connector is provided with at least one driven element that is arranged to be engageable with the lever.

12. The connection assembly according to claim 11, wherein the connection assembly comprises a first state, in which the mating connector is inserted into the receptacle of the electrical connector, the lever is in the initial position, and the blocking section abuts against the mating connector.

13. The connection assembly according to claim 12, wherein the connection assembly comprises a second state, in which the lever is in the pre-lock position and the blocking section is moved out of the abutment with the mating connector.

14. The connection assembly according to claim 13, wherein the connection assembly comprises a third state, in which the mating connector is inserted further into the receptacle of the electrical connector compared to the first state, the lever is in the prelock position, and a movement of the lever into the initial position is blocked by the mating connector.

15. The connection assembly according to claim 14, wherein the lever comprises at least one drive element that is arranged to be engageable with the at least one driven element of the mating connector, wherein the connection assembly comprises a fourth state, in which the mating connector is inserted further into the receptacle of the electrical connector compared to the third state, the at least one drive element is in engagement with the at least one driven element, and the lever is movable from the prelock position to the initial position.
